(19) United States
(12) Patent Application Publication
(10) Pub. No.: US 2025/0002184 A1
(43) Pub. Date: Jan. 2, 2025

(54) UNMANNED AERIAL SYSTEMS FOR USE IN SOLAR ENERGY INSTALLATIONS

(71) Applicant: SOLARGIK LTD, JERUSALEM (IL)

(72) Inventors: Gil Kroyzer, Jerusalem (IL); Israel Kroizer, Jerusalem (IL); Doron Weiss, Kiryat Ono (IL); Morag Am Shallem, Jerusalem (IL)

(21) Appl. No.: 18/214,976

(22) Filed: Jun. 27, 2023

(51) Int. Cl. B64U 20/87

(52) U.S. Cl. CPC B64U 20/87; G06V 10/00; H02S 20/32; B64U 2101/30; B64U 2201/20

(57) ABSTRACT

An unmanned aerial system (UAS) is provided for use in regulating operation of a solar energy system. The solar energy system comprises a plurality of photovoltaic (PV) modules and one or more drive systems configured to pivot the plurality of PV modules through respective ranges of orientations. The UAS comprises an unmanned aerial vehicle (UAV) programmable to fly in proximity to one or more PV modules, the proximity being in accordance with at least one of an imaging range and a communications range. The UAS also comprises an imaging device borne by the UAV and configured to capture one or more images of PV modules, and a communications device borne by the UAV and configured to transmit a command to a controller of the solar energy system to change an operating parameter of the PV modules.

### FIELD OF THE INVENTION

The present invention relates to solar energy systems and specifically to systems and methods for using unmanned aerial systems in the testing, configuring, commissioning, and operation of such solar energy systems.

### BACKGROUND

Achieving a diversified low-carbon emissions energy economy has been limited by economic and technological limitations. Solar energy systems comprising arrays of photovoltaic (PV) modules are commonly deployed to capture energy from both direct and diffuse (including reflected) solar irradiance. Tracking PV systems are deployed in which PV modules are pivoted to reduce optical losses from the direct irradiance component, including the so-called cosine loses wherein the energy absorbed is a function of the cosine of the angle between the incidence vector and a normal vector of the PV module.

PV modules serve to generate electricity when solar illumination is incident upon the panels. Generated electricity is typically fed into an electrical grid of the city/locality.

The use of unmanned aerial systems (UAS's) incorporating unmanned aerial vehicles for imaging arrays of PV modules has become popular in the industry, and especially for commissioning of solar energy systems before initial operation. Existing systems generally produce static, two-dimensional images of fixed-angle PV modules, and do not address the special needs related to commissioning and operating tracking PV systems, in which the arrays of PV modules are cause to pivot to track the sun across the sky.

### SUMMARY

An unmanned aerial system (UAS) is disclosed, according to embodiments of the invention, for regulating operation of a solar energy system. The solar energy system comprises a plurality of photovoltaic (PV) modules and one or more drive systems configured to pivot the plurality of PV modules through respective ranges of orientations. The UAS comprises: (a) an unmanned aerial vehicle (UAV) programmable to fly in proximity to one or more PV modules, the proximity being in accordance with at least one of an imaging range and a communications range; (b) an imaging device, borne by the UAV and configured to capture one or more images, respectively, of each of the one of more PV modules; and (c) a communications device, borne by the UAV and configured to transmit a command to a controller of the solar energy system to change an operating parameter of at least one of the one or more PV modules.

In some embodiments, the operating parameter can comprise a tracking state parameter. In some embodiments, the operating parameter can comprise a mechanical and/or electrical parameter of a respective component of the one or more PV modules.

In some embodiments, the UAS can additionally comprise a UAS-controller, borne by the UAV and configured to regulate operation of the imaging device and of the communications device. In some embodiments, the imaging device and the communications device can be in communication with and controlled by a ground-based UAS-controller.

In some embodiments, the transmitting of the command can be responsive to an analysis, by the controller, of a captured image. In some embodiments, the transmitted command can be formulated by the UAS-controller.

In some embodiments, the UAS can additionally comprise one or more non-imaging sensors borne by the UAV and configured to receive information from a component of the solar-energy system, the one or more non-imaging sensors comprising at least one of: an altimeter, a distance measure, an orientation sensor including an accelerometer and/or a gyroscope), a location sensor, an audio sensor, and an RFID tag reader. In some embodiments, the solar energy system can comprise a meteorological system, and the communications device borne by the UAV can be configured to be in communication with one or more components of the meteorological system.

A method is disclosed for regulating operation of a solar energy system using the unmanned aerial system (UAS) of any one or more of the embodiments disclosed hereinabove. The method can comprise: (a) flying the UAV in proximity to the one or more PV modules, the proximity being in accordance with at least one of an imaging range and a communications range; (b) capturing, by the imaging device borne by the UAV, one or more images, respectively, of each of the one of more PV modules; and (c) transmitting, by the communications device borne by the UAV, a command to a controller of the solar energy system to change an operating parameter of at least one of the one or more PV modules. In some embodiments of the method, the capturing the one or more images can include capturing, while at least one PV module is pivoting, multiple images of the at least one PV module at different respective orientations. In some such embodiments, the capturing can be while the at least one PV module is pivoting in response to the transmitting of the command.

A method is disclosed, according to embodiments of the invention, for regulating operation of a solar energy system using an unmanned aerial system (UAS). According to the method, the UAS comprising an unmanned aerial vehicle (UAV) and respective imaging and communications devices borne by the UAV, and the solar energy system comprises a plurality of photovoltaic (PV) modules and one or more drive systems configured to pivot the plurality of PV modules through respective ranges of orientations. The method comprises: (a) flying the UAV in proximity to one or more PV modules, the proximity being in accordance with at least one of an imaging range and a communications range; (b) capturing, by the imaging device borne by the UAV, one or more images, respectively, of each of the one of more PV modules; and (c) transmitting, by the communications device borne by the UAV, a command to a controller of the solar energy system to change an operating parameter of at least one of the one or more PV modules.

In some embodiments, the operating parameter can comprise a tracking state parameter, and the method can additionally comprise: changing a tracking state parameter in response to receiving the transmitted command. In some embodiments, the operating parameter can comprise a mechanical and/or electrical parameter of a respective component of the one or more PV modules, and the method can additionally comprise: operating the respective drive system of the one or more PV modules in accordance with the changed mechanical and/or electrical parameter.

In some embodiments, the method can be performed during commissioning of the solar energy system. In some embodiments, the method can be performed while the solar energy system is in commercial operation.

In some embodiments, the method can additionally comprise, following the capturing: formulating a command to change an operating parameter of the one or more PV modules, wherein transmitting the command to a controller of the solar energy system is responsive to an analysis, performed by a controller borne by the UAV, of a captured image.

In some embodiments, the transmitted command can be formulated by the controller.

In some embodiments, the flying, capturing and transmitting can be performed autonomously following a launch of the UAV.

In some embodiments, the capturing of the one or more images can include capturing, while at least one PV module is pivoting, multiple images of the at least one PV module at different respective orientations. In some embodiments, the capturing can be whilst the at least one PV module is pivoting in response to the transmitting of the command.

A method is disclosed, according to embodiments of the invention, for regulating operation of a solar energy system using an unmanned aerial system (UAS). According to the method, the UAS comprises an unmanned aerial vehicle (UAV) and respective imaging and communications devices borne by the UAV, and the solar energy system comprises a plurality of photovoltaic (PV) modules and one or more drive systems configured to pivot the plurality of PV modules through respective ranges of orientations. The method comprises: (a) flying the UAV in proximity to one or more PV modules, the proximity being in accordance with at least one of an imaging range and a communications range; (b) pivoting the one or more PV modules to a plurality of respective orientations; and (c) during the pivoting, capturing one or more images, respectively, of each of the one of more PV modules at different orientations, the capturing being by the imaging device borne by the UAV.

In some embodiments, the method can additionally comprise: analyzing the captured images to identify a defective or damaged component of the solar energy system, wherein the analyzing is performed by a controller of the UAS. In some embodiments, the method can additionally comprise: analyzing the captured images to identify a misaligned or displaced component of the solar energy system, wherein the analyzing is performed by a controller of the UAS. In some embodiments, the method can additionally comprise: analyzing the captured images to identify an environmental obstacle interfering with a pivoting movement of a PV module, wherein the analyzing is performed by a controller of the UAS.

In some embodiments, the controller of the UAS can be borne by the UAV during the flying.

In some embodiments, the pivoting can be in response to receiving a command transmitted by the communications device borne by the UAV to a controller of the solar energy system. In some embodiments, the command can be formulated by the controller of the UAS in response to an analysis, performed by the controller of the UAS, of the respective one or more captured images.

A method is disclosed, according to embodiments of the invention, for regulating operation of a solar energy system using an unmanned aerial system (UAS). According to the method, the UAS comprises an unmanned aerial vehicle (UAV) and respective imaging and communications devices borne by the UAV, and the solar energy system comprises a plurality of photovoltaic (PV) modules and one or more drive systems configured to pivot the plurality of PV modules through respective ranges of orientations. The method comprises: (a) flying the UAV in proximity to one or more PV modules, the proximity being in accordance with at least one of an imaging range and a communications range; (b) accessing a three-dimensional representation corresponding to a design of at least a portion of the solar energy system; (c) capturing, by the imaging device borne by the UAV, one or more images, respectively, of the at least a portion of the solar energy system; (d) creating, from the one or more captured images, a three-dimensional representation of the at least a portion of the solar energy system; and (e) comparing the created three-dimensional representation to the accessed three-dimensional representation to identify one or more divergences from the design.

In some embodiments, identifying the one or more divergences from the design can include determining that the one or more divergences are in one or more PV modules resident in the at least a portion of the solar energy system. In some such embodiments, the method can additionally comprise: transmitting, by the communications device borne by the UAV, a command to a controller of the solar energy system to change an operating parameter of the identified one or more PV modules; the changing can be to remedy at least one of the one or more divergences, and the operating parameter can include at least one of a tracking state parameter and a mechanical and/or electrical parameter.

In some embodiments, the capturing of the one or more images can include capturing, while at least one PV module is pivoting, multiple images of the at least one pivoting PV module at different respective orientations.

In some embodiments, identifying the one or more divergences from the design can include determining that the one or more divergences are in one or more respective components of the solar energy system that are not a component of a PV module.

### BRIEF DESCRIPTION OF THE DRAWINGS

The invention will now be described further, by way of example, with reference to the accompanying drawings, in which the dimensions of components and features shown in the figures are chosen for convenience and clarity of presentation and not necessarily to scale. In the drawings:

FIG. 1 shows a block diagram of a solar energy system, according to embodiments of the present invention.

FIG. 2 shows a schematic layout of selected components of a solar energy system according to embodiments of the present invention.

FIG. 3 shows a schematic layout of a PV array comprising multiple PV modules, according to embodiments of the present invention.

FIG. 4 shows a block diagram of a control system for a solar energy system, according to embodiments of the present invention.

FIG. 5 shows a block diagram of a meteorological system, according to embodiments of the present invention.

FIG. 6 is a schematic illustration of an unmanned aerial vehicle flying in proximity to a PV module and optionally communicating with controllers of a solar energy system and of an unmanned aerial vehicle, according to embodiments of the present invention.

FIGS. 7, 8A-D, 9A-D, and 10A-B show flowchart of methods and method steps for regulation operation of a solar energy system using an unmanned aerial system, according to embodiments of the present invention.

FIGS. 11A and 11B are schematic illustrations of a PV module pivoted to different orientations, according to embodiments of the present invention.

### DETAILED DESCRIPTION OF THE ILLUSTRATED EMBODIMENTS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are generally used to designate like elements.

Embodiments disclosed herein relate to unmanned aerial systems (UAS's) and unmanned aerial vehicles (UAVs) for use in commissioning, testing, maintaining, and operating solar energy systems comprising arrays photovoltaic (PV) modules. In particular, the embodiments relate to solar energy systems in which the PV modules are arranged to be pivoted by built-in drive systems to track the sun's location during the day and to complete other movements (such as, for example, moving to a safe or sleep position). Unlike fixed-angle PV systems, pivoting or ‘tracking’ PV systems can be imaged while pivoting through various orientations or at various orientations to increase the efficacy of the imaging for analysis and problem-solving, or alternatively for registering conformance to design and suitability for operation.

The UAVs, according to the embodiments disclosed herein, are programmed or programmable to fly autonomously, scan parts (or all) of the solar energy system with imaging and non-imaging sensors, analyze the results, and formulate and transmit commands to the control system of the solar energy system. Inter alia, the commands can be effective to solve potential operating problems, e.g., tracking speeds and orientations; to engage the PV modules in a testing process, e.g., by pivoting to different orientations, testing freedom of movement, performing pre-programmed movements such as moving to a safe or sleep position; to cause the PV modules to ‘show themselves’ to the imaging or non-imaging sensors in different orientations or to demonstrate movement for recording and analysis; or to solve a portion of the problems, or divergences from design, captured by the UAV imagers and sensors, and optionally analyzed/or and identified by a UAV controller, which can be onboard the UAV or, alternatively, ground-based but in wireless communication with the UAV through a ground station. In some of the embodiments disclosed herein, the commands are formulated by the UAV controller in response to analysis of imaging and/or non-imaging sensor data, and in some embodiments the analysis itself is performed by the UAV controller so as to create a programmable, autonomous tool for trouble-shooting and problem-solving as part of the UAS. In some of the embodiments disclosed herein, imaging can include scanning parts (or all) of the solar energy system to create three-dimensional representations of the solar energy system or any part thereof, e.g., for comparison to three-dimensional models of the system or portions thereof stored in controller memory or in a database optionally accessible by a controller of the UAS. In some embodiments, not all of the functions of the UAV are conducted autonomously and can involve operator interaction. In some embodiments, not all of the processing functions, e.g., analysis and formulation of commands for transmittal to the controller of the solar energy system are carried out by the UAS, and some functions may be carried out by operators or by the controller of the solar energy system.

A ‘solar energy system’ as used herein means a system for generating electricity using an array of PV modules. The system can include an inverter for converting the direct-current (DC) electricity generated by the PV modules to alternating current (AC) electricity, e.g., for delivery to an electricity grid.

A solar tracker, or simply ‘tracker’, is an arrangement that changes the orientation of the PV panels in response to commands from a controller. Whenever direct solar irradiance is available, the tracker is oriented and incrementally pivoted so as to capture, i.e., convert, the highest possible proportion of the direct irradiance falling on the panels over the course of nearly any given period of time, along with other components of solar irradiance, e.g., diffuse radiation. In some instances, the tracker is oriented to capture and convert energy up to a given maximum or setpoint. Capture and conversion of the diffuse radiation component of the incident solar irradiance is considerably smaller than that of the direct component for most hours in which the sun is not obscured, e.g., by clouds, and therefore the tracking is largely unaffected by distribution of diffuse radiation. In most cases, variation in the distribution of diffuse radiation becomes important only when the direct component is eliminated or reduced so as to no longer be the predominant component of the incident solar irradiance.

A single-axis tracker is one that rotates PV panels around a single axis, usually rotating from facing east to facing west over the course of a day around a north-south axis. A double-axis, or two-axis, tracker is one that is designed to generally have the PV panels ‘face’ the sun directly at all times so as to capture and convert as much energy as possible from available direct irradiance by reducing the angle between a normal vector of the PV panels and incident direct irradiance to zero, or substantially zero, in not just one plane but all planes. Some double-axis trackers operate using Euler angles and do not, strictly speaking, rotate the PV panels about two Cartesian axes, but the results are substantially the same. The embodiments disclosed herein are described in terms of single-axis tracking, but their application, mutatis mutandis, to double-axis tracking, is within the scope of the present invention, as will be clear to the skilled artisan.

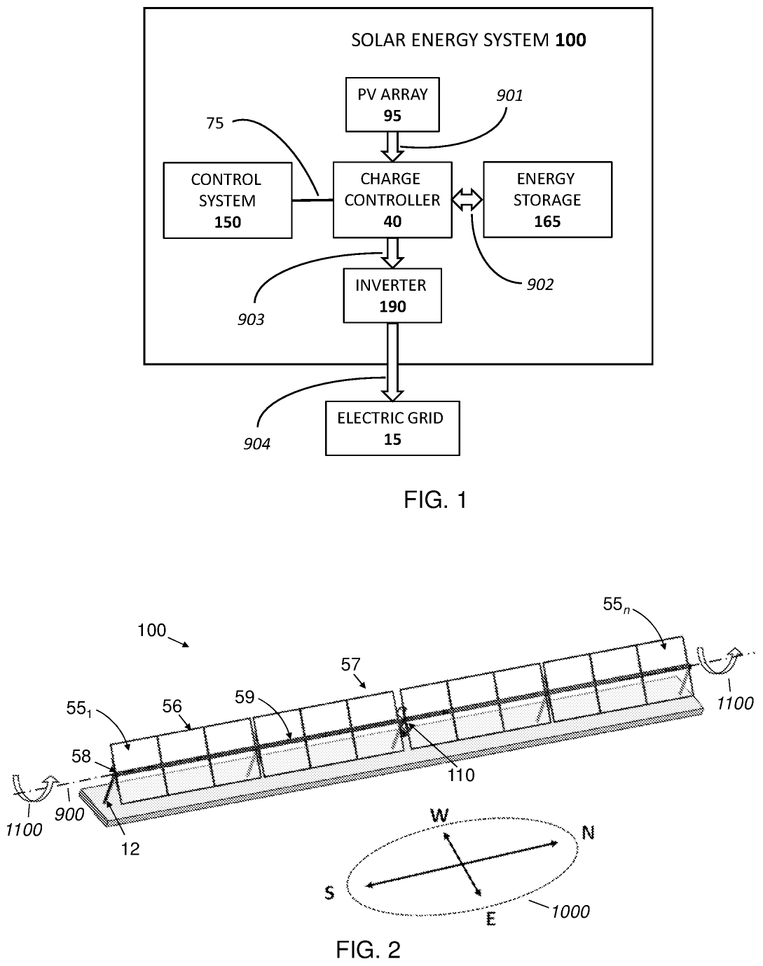

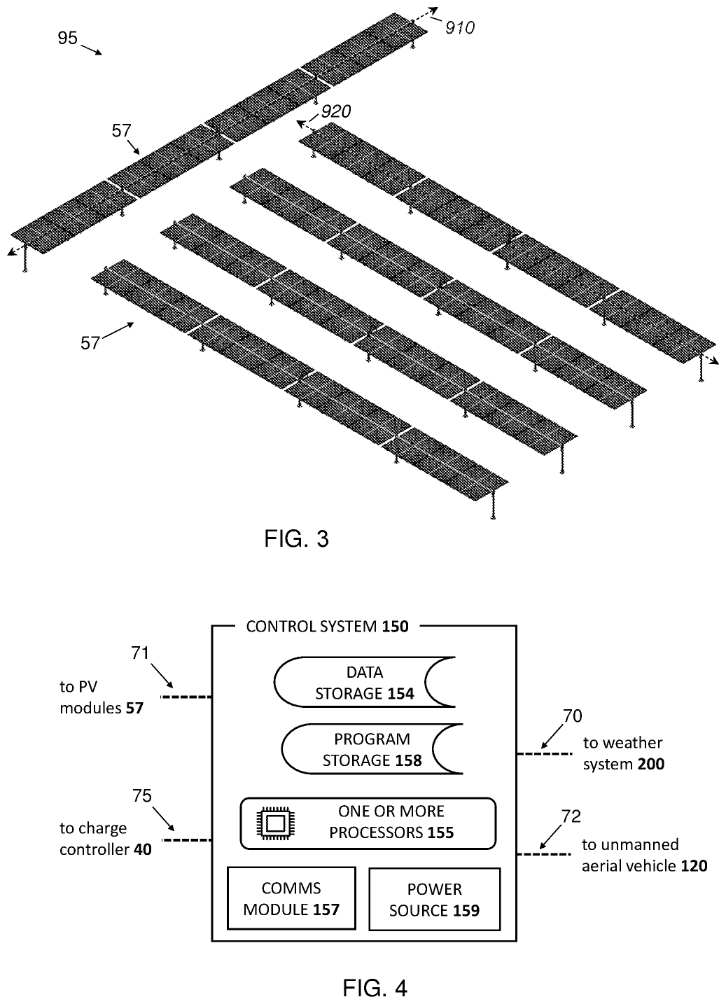

Referring now to the figures, and in particular to FIG. 1, a solar energy system 100 according to embodiments includes a PV array 95 comprising a plurality of PV modules 57 (shown, e.g., in FIG. 2). In embodiments, the modules 57 of the PV array 95 includes a tracking component, i.e., a solar tracker, for increasing cumulative electricity generated over the course of a period of time.

The solar system 100 of FIG. 1 additionally includes an inverter 190 for conversion of DC electricity to AC. An inverter can include electronic circuitry, for example for synchronizing the phase, and for matching the voltage and frequency of the power output to those of the grid.

FIG. 1 further illustrates a non-limiting example of a power flow scheme for a solar energy system 100: power generated by the PV array 95 flows to a charge controller 40 as indicated by arrow 901. Two-way power flow takes place between the charge controller 40 and an energy storage device 165, as indicated by two-way arrow 902. Power from the PV array 95 and the energy storage device 165 flows through the charge controller 40 to the inverter 190, as indicated by arrow 903. The inverter 190 can deliver energy to the electric grid 15, as indicated by arrow 904.

Referring now to FIG. 2, a solar energy system 100 according to embodiments, employing single-axis tracking, a PV array 95 includes one or more PV modules 57. The PV module 57 includes n PV panels 551 through 55n, joined to a support subassembly 58. The support subassembly 58 includes frames 56 for mounting the PV panels 55, and a central elongated member 59 to which the frames 56 are joined. The central elongated member 59 serves to transfer a torque to rotate the frames 56 as a unit together with the central elongated member 59 and the PV panels 55. The PV module 57 is rotated about a central longitudinal axis indicated in FIG. 2 by dashed line 900, and the rotation is schematically represented by arrows 1100. The central elongated member 59 is pivotably supported by ground supports 12. As shown by axes 1000, the panels are facing generally east, indicating that FIG. 2 shows a morning orientation. The tracking of the PV module 57 is shown as being east-west tracking as is the case in the vast majority of current installations of PV modules, but the principles disclosed here are equally applicable to north-south tracking systems, mutatis mutandis. A drive system 110 according to embodiments includes a motor assembly and a pivot wheel, and is also supported by a ground support 12. The drive system 110, as shown in FIG. 2, can be located in the center of the PV assembly 57. In other examples, a drive system 110 can be located elsewhere and/or configured differently than the example illustrated. In embodiments, the drive system 110 is operable to rotate a pivot wheel positioned to rotate the central elongated member 59 and, with it, the PV module 57.

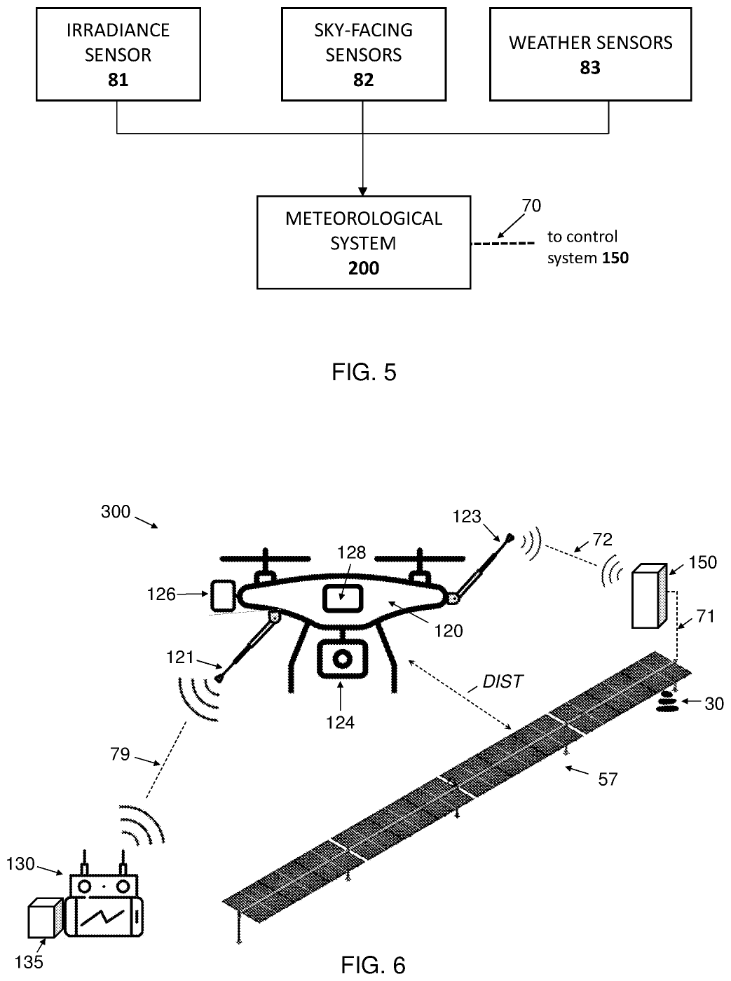

In a solar energy system 100 comprising multiple rows of single-axis PV modules 57, i.e., where drive systems 110 of are configured to pivot the plurality of PV modules 57 about respective single longitudinal axes, the PV modules 57 can be deployed in parallel rows or not all in parallel rows. Referring to FIG. 3, a PV array 95 comprising a plurality of PV modules 57 are shown as having respective single longitudinal axes 910, 920 that are not all parallel to each other.

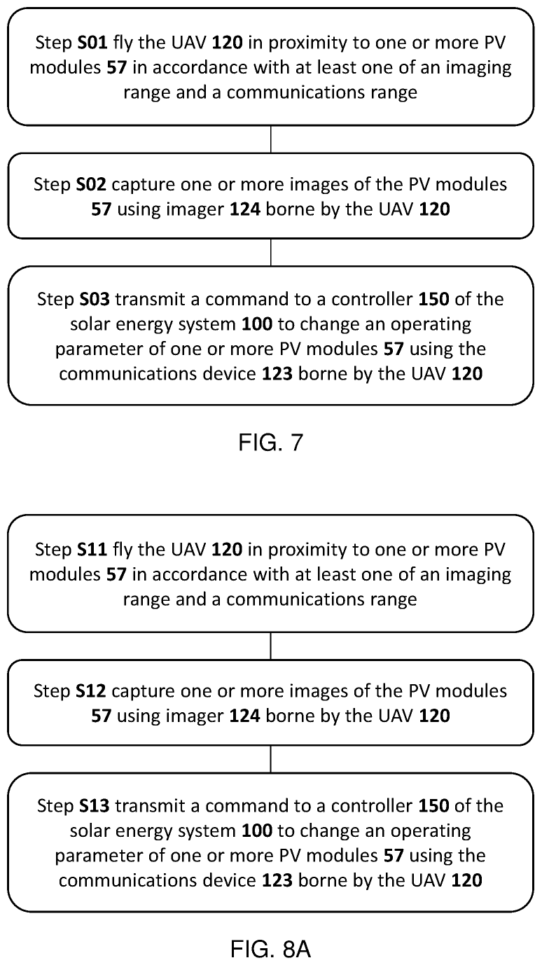

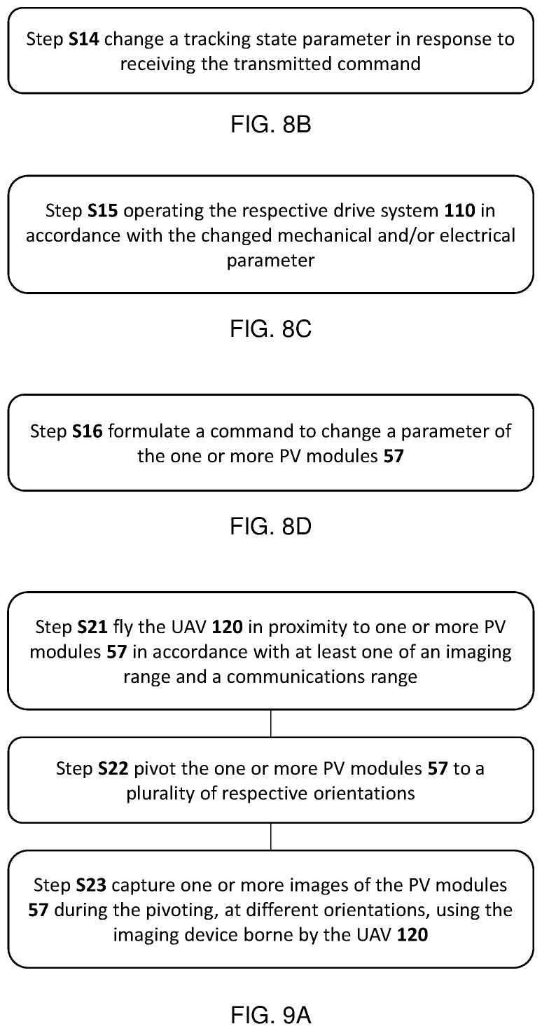

A control system 150, (also called a ‘controller’) for a solar energy system 100, according to embodiments, is illustrated schematically in FIG. 4 to show selected components. The exemplary control system 150 of FIG. 4 includes one or more computer processors 155, a computer-readable storage medium 158, a communications module 157, and a power source 159. The computer-readable storage medium 158 can include transient and/or non-transient storage, and can include one or more storage units, all in accordance with desired functionality and design choices. The storage 158 can be used for any one or more of: storing program instructions, in firmware and/or software, for execution by the one or more processors 155 of the control system 150. In embodiments, the stored program instructions include program instructions for operating a solar energy system 100. Data storage 154, if separate from storage 158, can be provided for historical data, e.g., actual irradiance and/or forecast values, e.g., forecasted irradiance values, and other data related to the operation of the solar energy system 100. In some embodiments, the two storage modules 154, 158 form a single module. The communications module 159 is configured to establish communications links, e.g., via communication arrangements 70 with a meteorological system 200 (described below and illustrated schematically in FIG. 5); with the charge controller 40 via communications arrangements 75; with the PV modules 57 via communications arrangements 71; and with an unmanned aerial vehicle 120 according to embodiments disclosed hereinbelow, via communications arrangements 72. In some embodiments, a control system 150 does not necessarily include all of the components shown in FIG. 2. The terms “communications arrangements” or similar terms such as “communications links” as used herein mean any wired connection or wireless connection via which data communications can take place. Non-limiting and non-exhaustive examples of suitable technologies for providing communications arrangements include any short-range point-to-point communication system such as IrDA, RFID (Radio Frequency Identification), TransferJet, Wireless USB, DSRC (Dedicated Short Range Communications), or Near Field Communication; wireless networks (including sensor networks) such as: ZigBee, EnOcean; Wi-fi, Bluetooth, TransferJet, or Ultra-wideband; and wired communications bus technologies such as. CAN bus (Controller Area Network, Fieldbus, FireWire, HyperTransport and InfiniBand.

In addition to the control system 150 illustrated in the block diagram of FIG. 4, any of the other controllers or control systems disclosed herein can have similar sets of components, such as one or more computer processors, transient and/or non-transient storage for programs and/or data, and network and other communications interfaces.

In operating a solar energy system, it can be desirable to access current and/or forecasted meteorological data and other sensor data, e.g., for predicting the intensity of the various components of solar radiance, for measuring current environmental parameters such as wind speed and direction, humidity, and direct and non-direct components of solar irradiance. The block diagram of FIG. 5 shows examples of components, according to embodiments, in a meteorological system 200. The non-exhaustive list of components includes one or more irradiance sensors 81, sky-facing optical sensors 82, and a weather station comprising weather sensors 83 for measuring, e.g., and not exhaustively: wind speed and direction, humidity, and temperature.

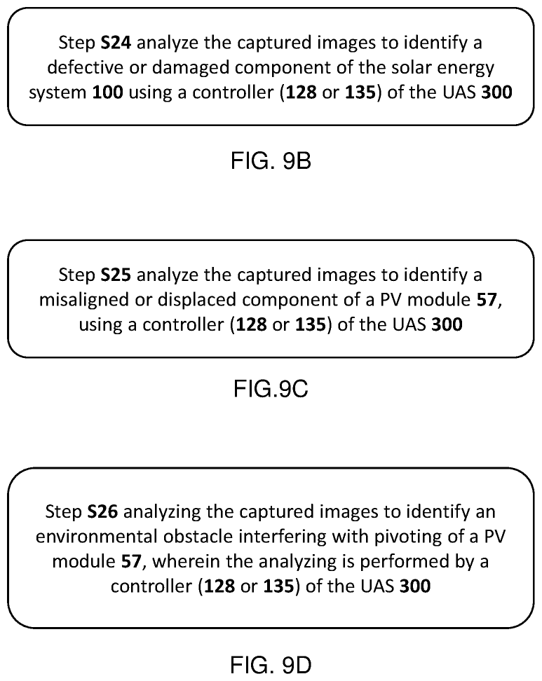

We now refer to FIG. 6, which illustrates embodiments related to design and operation of an unmanned aerial system (UAS) 300, provided for regulating operation of a solar energy system 100, e.g., any of the solar energy systems 100 disclosed herein. ‘Operation’ of a solar energy system 100 includes commissioning activities during and after construction, and regular operation before and during commercial operations. ‘Regulating’ includes (i) directly controlling the operation of one or more components of the solar energy system, and/or (ii) indirectly controlling the operation and/or affecting an aspect of the operation, by testing, commissioning, maintaining, modifying, replacing, adjusting, changing a parameter value of any of system component, including of hardware, software and firmware components. Such regulating may impact current operation or future operation of the solar energy system.

The UAS 300 of FIG. 6 includes an unmanned aerial vehicle (UAV) 120 capable of self-powered flight. In embodiments, the UAV 120 is programmable to fly in proximity to one or more PV modules 57 of a solar energy system 100. “Proximity” means that at least one of the following conditions is met: (a) the UAV 120 is within an ‘imaging range’ relative to the PV module(s) 57 for capturing, with onboard imaging devices 124, a desired portion of the solar energy system 100 and/or of the PV module(s) at a desired resolution that is sufficient for the purposes disclosed herein, and (b) the UAV is within a “communications range” that enables communications between an onboard communications device 123 and a controller 150 of the solar energy system 100 that is arranged to control, inter alia, pivoting of the PV module(s) 57. In FIG. 6, the position of the UAV 120 is at a range marked DIST relative to a PV module 57, the position being selected to be within at least one of the imaging range and the communication range relative to the PV module 57.

The UAV of FIG. 6 carries a communication device 121 attuned to and responsive to the commands of, and in at least one-way wireless communication with, a ground station 130, as indicated by wireless communications link 79 in FIG. 6. The ground station 130 can include, or be in communication with, a ground-based UAS controller 135, which in some embodiments performs analyses of data and/or images received from the UAV 120, and/or formulates commands to be transmitted by the UAV 120 to a controller 150 of the solar energy system 100, typically along with other functions of the UAV not disclosed in the present embodiments. In addition to or as an alternative to the ground-based UAS controller 135, an airborne UAS controller 128 is carried by the UAV 120 in some designs.

The UAS 300 also includes at least one imaging device 124 carried by the UAV 120 when flying and configured, to capture one or more images that show each of the one of more PV modules 57 or any other part of a solar energy system 100 to be imaged. “Configured” with respect to the imaging device 124 can mean any one or more (or all) of the following: programmed or programmable, aimed or aimable, focused or focusable, having a desired pixel capability, having a desired image storage capacity, and appropriate exposure and aperture settings, for capturing the desired images. The imaging device 124 can employ any imaging technology deemed appropriate, including, and not exhaustively, visual-range photography, infrared-range photography, radar and/or lidar.

The exemplary UAS 300 of FIG. 6 also includes a communications device 123 including at least a transmitter for communicating with a controller 150 of the solar energy system 100, as indicated by wireless communications link 72 in FIG. 6. In embodiments, the controller 150 controls at least a tracking state parameter of one or more PV modules 57 of the solar energy system 100. The communications device 123 for communicating with the controller 150 of the solar energy system 100 can be the same communications device as the communications device 121 for communicating with the ground station 130, or can be a different device, and can, as appropriate, operate using the same or different wireless technologies, frequencies or communications protocols.

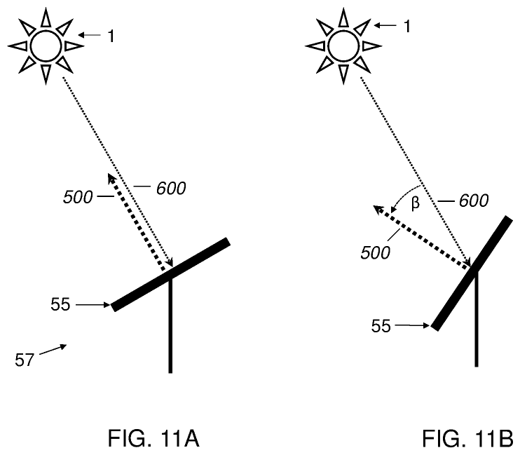

The “tracking state parameter” of a PV module 57 can include, and not exhaustively: tracking on-sun as illustrated schematically in FIG. 11A, in which the PV module 57 follows the path of the sun 1 across the sky during the day, e.g., to minimize an angle between the vector of incident direction radiation 600 and a normal vector 500 of the sun-facing surface of the PV panel 55; pivoting to an angle away from the on-sun position as illustrated schematically in FIG. 11B, in which the sun-facing surface of the PV panel 55 is pivoted such that its normal vector 500 is angularly displaced by an angle β away from the vector of incident direction radiation 600; and any other pivoting movement of the PV module 57 to any selected orientation. Exemplary tracking-state parameters can also be understood as ‘logical’ parameters, i.e., parameters that regulate the behavior of the PV modules in various situations including the aforementioned tracking states.

Additionally or alternatively, the controller 150 is configured to control an operating parameter of one or more PV modules 57 that is a mechanical parameter or an electrical parameter, or both. Examples of such mechanical and/or electrical parameters include, and not exhaustively: a rate of motor movement pulses, a number of motor movement pulses, and a pivot arc limit.

The communications device 123 is configured, e.g., programmed or programmable, and using suitable technology, frequencies, coding and formats, to transmit a command to the controller 150 of the solar energy system to change an operating parameter of at least one of the one or more PV modules 57, where the operating parameter can include either or both of a tracking state parameter, and a mechanical parameter and/or electrical parameter. In embodiments, tracking-state parameters in commands sent to the controller 150 can include ‘logical’ parameters, i.e., parameters that regulate the behavior of the PV modules in various situations, e.g., so that the UAS 300 can acquire relevant data. Illustrative examples of logical-parameter commands include ‘pivot until an environmental obstruction is reached’, or ‘pivot to a wind-safe position’.

In embodiments, the transmitted command is transmitted after an analysis of one or more images captured by the imaging device 124. The analysis can be performed by the airborne UAS controller 128 carried by the UAV 120 or by the ground-based UAS controller 135. Similarly, the command may be formulated (e.g., generated and/or selected from a command database) by the airborne UAS controller 128 carried by the UAV 120 or by the ground-based UAS controller 135.

The data capture capabilities of the UAS include, in some embodiments, one or more non-imaging sensors 126 carried by the UAV 120. Examples of non-imaging sensors include, and not exhaustively: an altimeter, a distance measure, an orientation sensor (e.g., including an accelerometer and/or a gyroscope), a location sensor, an audio sensor such as a microphone, and an RFID tag reader. Any of the embodiments disclosed with respect to imaging, including analysis of captured images, and formulating and transmitting commands to the controller 150 to be carried out by the PV module(s) 57, responsively to capture and/or analysis of images, are applicable, mutatis mutandis, to sensor data collected by non-imaging sensors.

In some embodiments, the UAV 120 is in communication, via communications device 123, with one or more components of the meteorological system 200, for example to image or test components with moving parts, or to image components and examine for proper installation and lack of damage or defects.

Various methods are disclosed herein for regulating operation of a solar energy system using a UAS. Any of the methods can be carried out during the construction and/or commissioning of a solar energy system or a part of the solar energy system. Additionally or alternatively, any of the methods can be carried out while the solar energy system is in commercial operation, whether actively in operation or during a ‘rest’ period, e.g., at night, or in connection with periodic, preventive, or other maintenance or surveying of the solar energy system. In any of the methods, at least the flying and the capturing of images can be performed autonomously following a launch of the UAV.

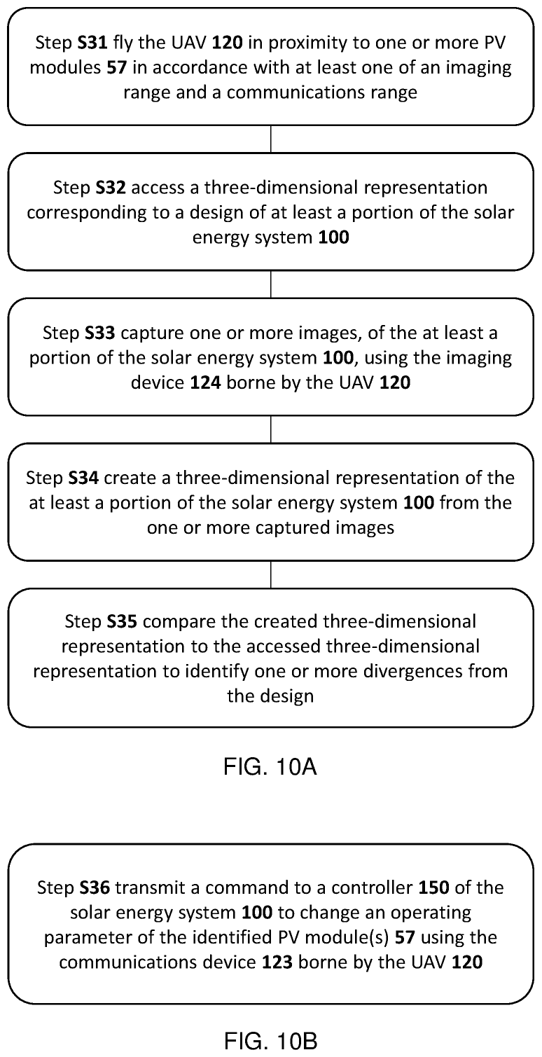

Referring now to FIG. 7, a method is disclosed for regulating operation of a solar energy system 100 using a UAS 300 provided in accordance with any of the embodiments disclosed herein and as schematically illustrated in FIG. 6. As illustrated by the flow chart in FIG. 7, the method comprises at least the three method steps S01, S02 and S03.

Step S01 includes flying the UAV 120 in proximity to the one or more PV modules 57; the proximity is in accordance with at least one of an imaging range and a communications range of the imaging device 124 and the communications device 123, respectively, carried by the UAV 120.

Step S02 includes capturing one or more images, respectively, of each of the one of more PV modules 57, using the imaging device 124 carried by the UAV 120. In some embodiments, the capturing of images includes capturing multiple images of the at least one PV module 57 at different respective orientations while at least one PV module 57 is actively pivoting.

Step S03 includes transmitting one or more commands to a controller 150 of the solar energy system 100 to change an operating parameter of at least one of the one or more PV modules 57, using the communications device 123 carried by the UAV 120.

In some embodiments, the capturing of images of Step S02 is performed while the at least one PV module 57 is pivoting in response to the transmitting of the command(s) of Step S03.

Referring now to FIG. 8A, a method is disclosed for regulating operation of a solar energy system 100 using a UAS 300 comprising a UAV 120 and respective imaging and communications devices 124, 123 borne by the UAV 120. According to the method, the solar energy system 100 comprises a plurality of PV modules 57 and one or more drive systems 110 configured to pivot the plurality of PV modules 57 through respective ranges of orientations. As illustrated by the flow chart in FIG. 8A, the method comprises at least the three method steps S11, S12 and S13.

Step S11 includes flying the UAV 120 in proximity to the one or more PV modules 57; the proximity is in accordance with at least one of an imaging range and a communications range of the imaging device 124 and the communications device 123, respectively, carried by the UAV 120.

Step S12 includes capturing one or more images, respectively, of each of the one of more PV modules 57, using the imaging device 124 carried by the UAV 120. In embodiments, the capturing of images includes capturing multiple images of the at least one PV module at different respective orientations while at least one PV module 57 is actively pivoting.

Step S13 includes transmitting one or more commands to a controller 150 of the solar energy system 100 to change an operating parameter of at least one of the one or more PV modules 57, using the communications device 123 carried by the UAV 120.

In some embodiments, all of Steps S11, S12 and S13 are carried out autonomously after launch of the UAV 120.

In some embodiments, the capturing of images of Step S12 is performed while the at least one PV module 57 is pivoting in response to the transmitting of the command(s) of Step S13.

In some embodiments, the operating parameter changed in Step S13 comprises a tracking state parameter. In such embodiments, as illustrated by the flow chart in FIG. 8B, the method additionally comprises Step S14.

Step S14 includes changing a tracking state parameter in response to receiving the transmitted command. In a non-limiting example, the changed tracking state parameter includes changing an orientation of one or more PV modules 57.

In some embodiments, the operating parameter changed in Step S13 comprises a mechanical and/or electrical parameter of a respective component of the one or more PV modules 57. In such embodiments, as illustrated by the flow chart in FIG. 8C, the method additionally comprises Step S15.

Step S15 includes operating the respective drive system(s) 110 of the one or more PV modules 57 in accordance with the changed mechanical and/or electrical parameter. In a non-limiting example, the changed mechanical and/or electrical parameter includes a motor pulse rate of a PV module 57.

In some embodiments, as illustrated by the flow chart in FIG. 8D, the method additionally comprises Step S16.

Step S16 includes formulating a command to change an operating parameter (a tracking-state parameter, or a mechanical and/or electrical parameter) of the one or more PV modules 57. In some of the embodiments in which Step S16 is carried out, transmitting the command in Step S13 can be responsive to an analysis, performed by the controller 128 borne by the UAV 120, of one or more captured images. In some embodiments, the transmitted command is formulated by the controller 128 carried by the UAV 120.

Referring now to FIG. 9A, a method is disclosed for regulating operation of a solar energy system 100 using a UAS 300 comprising a UAV 120 and respective imaging and communications devices 124, 123 borne by the UAV 120. According to the method, the solar energy system 100 comprises a plurality of PV modules 57 and one or more drive systems 110 configured to pivot the plurality of PV modules 57 through respective ranges of orientations. As illustrated by the flow chart in FIG. 9A, the method comprises at least the three method steps S21, S22 and S23.

Step S21 includes flying the UAV 120 in proximity to one or more PV modules 57, the proximity being in accordance with at least one of an imaging range and a communications range.

Step S22 includes pivoting the one or more PV modules 57 to a plurality of respective orientations. In some embodiments, the pivoting is in response to receiving a command transmitted by the communications device 124 borne by the UAV 120 to a controller 150 of the solar energy system 100. In some embodiments, the command to pivot is formulated by the controller 128 of the UAS 300 (the controller 128 borne by the UAV 120) during the flying, in response to an analysis of the respective one or more captured images performed by the controller 128.

Step S23 includes capturing one or more images, respectively, of each of the one of more PV modules 57 at different orientations during the pivoting of Step S22. The capturing of images is carried out by the imaging device 124 borne by the UAV 120.

In some embodiments, as illustrated by the flow chart in FIG. 9B, the method additionally comprises Step S24.

Step S24 includes analyzing the images captured in Step S23 to identify a defective or damaged component of the solar energy system 100. According to embodiments, the analyzing is performed by a controller of the UAS 300—the airborne controller 128 or the ground-based controller 135.

In some embodiments, as illustrated by the flow chart in FIG. 9C, the method additionally comprises Step S25.

Step S25 includes analyzing the images captured in Step S23 to identify a misaligned or displaced component of the solar energy system 100. According to embodiments, the analyzing is performed by a controller of the UAS—the airborne controller 128 or the ground-based controller 135.

In some embodiments, as illustrated by the flow chart in FIG. 9D, the method additionally comprises Step S26.

Step S26 includes analyzing the images captured in Step S23 to identify an environmental obstacle interfering with a pivoting movement of a PV module 57. An example of an environmental obstacle is the small pile of rocks 30 shown schematically in FIG. 6. Another example of an environmental obstacle, not shown, is plant growth. According to the method, the analyzing is performed by a controller of the UAS—the airborne controller 128 or the ground-based controller 135.

Referring now to FIG. 10A, a method is disclosed for regulating operation of a solar energy system 100 using a UAS 300 comprising a UAV 120 and respective imaging and communications devices 124, 123 borne by the UAV 120. According to the method, the solar energy system 100 comprises a plurality of PV modules 57 and one or more drive systems 110 configured to pivot the plurality of PV modules 57 through respective ranges of orientations. As illustrated by the flow chart in FIG. 10A, the method comprises at least the five method steps S31, S32, S33, S34, and S35.

Step S31 includes flying the UAV 120 in proximity to one or more PV modules 57, the proximity being in accordance with at least one of an imaging range and a communications range.

Step S32 includes accessing a three-dimensional representation corresponding to a design of at least a portion of the solar energy system 100. The accessing can include retrieving the three-dimensional representation from a computer storage, e.g., data storage 154 of the controller 150 of the solar energy system 100, or from a remote computer, e.g., in the cloud.

Step S33 includes capturing one or more images, respectively, of the at least a portion of the solar energy system 100, using the imaging device 124 borne by the UAV 120. The at least a portion of the solar energy system 100 can include one or more PV modules 57 or components thereof, and/or components of the solar energy system 100 that are not components of the PV modules 57. In some embodiments, the capturing of images includes capturing multiple images of the at least one PV module 57 at different respective orientations while at least one PV module 57 is actively pivoting

Step S34 includes creating, from the one or more captured images, a three-dimensional representation of the at least a portion of the solar energy system 100.

Step S35 includes comparing the created three-dimensional representation to the accessed three-dimensional representation to identify one or more divergences from the design. In some embodiments, identifying the one or more divergences from the design includes determining that the one or more divergences are in one or more PV modules 57 resident in the at least a portion of the solar energy system 100. In some embodiments, identifying the one or more divergences from the design includes determining that the one or more divergences are in one or more respective components of the solar energy system 100 that are not a component of a PV module 57.

In some embodiments, as illustrated by the flow chart in FIG. 10B, the method additionally comprises Step S36.

Step S36 includes transmitting a command to a controller of the solar energy system to change an operating parameter of the identified one or more PV modules 57. According to the method, the transmitting is via the communications device 123 borne by the UAV 120, and changing the operating parameter is in order to remedy at least one of the one or more divergences identified in Step S35. The operating parameter, according to the method, includes at least one of a tracking state parameter and a mechanical and/or electrical parameter.

In some embodiments, divergences from design include physical issues that cannot be solved by the UAV autonomously. Examples include problems caused by the terrain surrounding the tracker panel, such as a misplacement of equipment placing it closer than desired to an obstacle such as a wall, or plants that have grown near the PV module since the location was surveyed to complete the design; broken or defective equipment, e.g., a broken PV panel, a loose drive chain, a broken bolt, an overheating or non-performing motor, and the like. In other embodiments, divergences can include operational or physical issues that can be solved by the UAV by transmitting commands to the controller of the solar energy system to change an operating parameter.

Steps of any of the foregoing methods can be combined with steps from other methods. Not all steps of all methods are required to be carried out.

It will be appreciated that the above descriptions are intended only to serve as examples, and that many other embodiments are possible within the scope of the present invention and as defined in the appended claim.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons skilled in the art to which the invention pertains.

1. An unmanned aerial system (UAS) for regulating operation of a solar energy system, the solar energy system comprising a plurality of photovoltaic (PV) modules and one or more drive systems configured to pivot the plurality of PV modules through respective ranges of orientations, the UAS comprising:
a. an unmanned aerial vehicle (UAV) programmable to fly in proximity to one or more PV modules, the proximity being in accordance with at least one of an imaging range and a communications range;
b. an imaging device, borne by the UAV and configured to capture one or more images, respectively, of each of the one of more PV modules; and
c. a communications device, borne by the UAV and configured to transmit a command to a controller of the solar energy system to change an operating parameter of at least one of the one or more PV modules.

2. The UAS of claim 1, wherein the operating parameter comprises a tracking state parameter.

3. The UAS of claim 1, wherein the operating parameter comprises a mechanical and/or electrical parameter of a respective component of the one or more PV modules.

4. The UAS of claim 1, additionally comprising a UAS-controller, borne by the UAV and configured to regulate operation of the imaging device and of the communications device.

5. The UAS of claim 1, wherein the imaging device and the communications device are in communication with and controlled by a ground-based UAS-controller.

6. The UAS of claim 4, wherein the transmitting of the command is responsive to an analysis, by the controller, of a captured image.

7. The UAS of claim 4, wherein the transmitted command is formulated by the UAS-controller.

8. The UAS of claim 1, additionally comprising one or more non-imaging sensors borne by the UAV and configured to receive information from a component of the solar-energy system, the one or more non-imaging sensors comprising at least one of: an altimeter, a distance measure, an orientation sensor including an accelerometer and/or a gyroscope), a location sensor, an audio sensor, and an RFID tag reader.

9. The UAS of claim 1, wherein the solar energy system comprises a meteorological system, and the communications device borne by the UAV is configured to be in communication with one or more components of the meteorological system

10. A method of regulating operation of a solar energy system using the unmanned aerial system (UAS) of claim 1, the method comprising:
a. flying the UAV in proximity to the one or more PV modules, the proximity being in accordance with at least one of an imaging range and a communications range;
b. capturing, by the imaging device borne by the UAV, one or more images, respectively, of each of the one of more PV modules; and
c. transmitting, by the communications device borne by the UAV, a command to a controller of the solar energy system to change an operating parameter of at least one of the one or more PV modules.

11. The method of claim 10, wherein the capturing the one or more images includes capturing, while at least one PV module is pivoting, multiple images of the at least one PV module at different respective orientations.

12. The method of claim 11, wherein the capturing is while the at least one PV module is pivoting in response to the transmitting of the command.

13-22. (canceled)

23. A method of regulating operation of a solar energy system using an unmanned aerial system (UAS), the UAS comprising an unmanned aerial vehicle (UAV) and respective imaging and communications devices borne by the UAV, the solar energy system comprising a plurality of photovoltaic (PV) modules and one or more drive systems configured to pivot the plurality of PV modules through respective ranges of orientations, the method comprising:
a. flying the UAV in proximity to one or more PV modules, the proximity being in accordance with at least one of an imaging range and a communications range;
b. pivoting the one or more PV modules to a plurality of respective orientations; and
c. during the pivoting, capturing one or more images, respectively, of each of the one of more PV modules at different orientations, the capturing being by the imaging device borne by the UAV.

24. The method of claim 23, additionally comprising: analyzing the captured images to identify a defective or damaged component of the solar energy system, wherein the analyzing is performed by a controller of the UAS.

25. The method of claim 23, additionally comprising: analyzing the captured images to identify a misaligned or displaced component of the solar energy system, wherein the analyzing is performed by a controller of the UAS.

26. The method of claim 23, additionally comprising: analyzing the captured images to identify an environmental obstacle interfering with a pivoting movement of a PV module, wherein the analyzing is performed by a controller of the UAS.

27. The method of claim 24, wherein the controller of the UAS is borne by the UAV during the flying.

28. The method of claim 23, wherein the pivoting is in response to receiving a command transmitted by the communications device borne by the UAV to a controller of the solar energy system.

29. The method of claim 28, wherein the command is formulated by the controller of the UAS in response to an analysis, performed by the controller of the UAS borne by the UAV during the flying, of the respective one or more captured images.

30. A method of regulating operation of a solar energy system using an unmanned aerial system (UAS), the UAS comprising an unmanned aerial vehicle (UAV) and respective imaging and communications devices borne by the UAV, the solar energy system comprising a plurality of photovoltaic (PV) modules and one or more drive systems configured to pivot the plurality of PV modules through respective ranges of orientations, the method comprising:
a. flying the UAV in proximity to one or more PV modules, the proximity being in accordance with at least one of an imaging range and a communications range;
b. accessing a three-dimensional representation corresponding to a design of at least a portion of the solar energy system;
c. capturing, by the imaging device borne by the UAV, one or more images, respectively, of the at least a portion of the solar energy system;
d. creating, from the one or more captured images, a three-dimensional representation of the at least a portion of the solar energy system; and
e. comparing the created three-dimensional representation to the accessed three-dimensional representation to identify one or more divergences from the design.

31-34. (canceled)
